(19) United States
(12) Patent Application Publication
(10) Pub. No.: US 2026/0048523 A1
(43) Pub. Date: Feb. 19, 2026

(54) PUNCHING MACHINE WITH REPLACEABLE PUNCHING CORE

(71) Applicant: Haocai ZHENG, Dongguan City (CN)

(72) Inventor: Haocai ZHENG, Dongguan City (CN)

(73) Assignee: DONGGUAN JIAXI OFFICE MACHINE CO., LTD., Dongguan City (CN)

(21) Appl. No.: 19/369,226

(22) Filed: Oct. 26, 2025

(30) Foreign Application Priority Data
Aug. 14, 2025 (CN) 202521736711.5

(51) Int. Cl. B26F 1/14

(52) U.S. Cl. CPC B26F 1/14

(57) ABSTRACT

A punching machine with a replaceable punching core, including: a mounting base, a replaceable punching core, a control handle, an elastic reset assembly and drive-transmission mechanism. The replaceable punching core is positioned and aligned by matching a bottom outer contour with the installing recess, allowing for tool-free disassembly and replacement, which improves maintenance efficiency and functional flexibility. Adopting a driving gear and a transmission assembly with a hole that meshes with a belt drive, converting the rotational motion of the control handle into vertical punching force. Combined with an elastic reset assembly, the control handle automatically resets after punching. Additionally, the limit component reduces overall height of punching machine, overcoming storage bottleneck. Its beneficial effects include achieving blade core replacement in seconds, smooth and effortless operation, compact structure, high space utilization, and suitability for efficient punching needs in various scenarios, such as office documents and handicrafts.

### CROSS-REFERENCE TO RELATED APPLICATIONS

The is disclosure claims foreign priority of Chinese Patent disclosure No. 202521736711.5, filed on Aug. 14, 2025 in the China National Intellectual Property Administration, the disclosures of all of which are hereby incorporated by reference.

### TECHNICAL FIELD

The present disclosure relates to the technical field of office punching equipment, in particular to a punching machine with a replaceable punching core.

### BACKGROUND

With the increasing demand for office automation and personalization, there is a growing need for efficient and flexible punching of sheet materials such as documents, invoices, leather, and crafts. Consumers, while pursuing convenience in punching operations and a variety of functions, have higher requirements for the ease of maintenance, labor-saving operation, and compact overall structure of the equipment.

Currently, punching machines on the market generally exhibit the following significant issues: the punching core is not replaceable or the replacement operation is complicated, leading to high maintenance costs. Mainstream punching machines usually adopt fixed punching heads or complex replaceable punching designs. When the punching head wears out and needs replacing, or when users need to switch between different punching diameters or shapes, they often need to use tools for cumbersome disassembly, sometimes requiring the removal of multiple components or adjusting precise alignment mechanisms. This not only makes the operation time-consuming and labor-intensive, resulting in a poor user experience, but also causes long downtime and high maintenance costs. Frequent disassembly may also accelerate wear on the related connection structures, affecting the overall lifespan and precision of the equipment.

To address this, the present disclosure provides a punching machine with a replaceable punching core, which can effectively solve the above problems.

### SUMMARY

The present disclosure provides a punching machine with a replaceable punching core, to overcome the deficiencies of the existing technology.

To realize the above objective, the present disclosure provides a punching machine with a replaceable punching core, including: a mounting base, which is configured for carrying a sheet material to be punched; and a replaceable punching core, which is detachably mounted on the mounting base, and the replaceable punching core includes a punching assembly; and a control handle, which is rotatably connected to the mounting base: when the control handle rotates, the punching assembly of the replaceable punching core is driven to move downward, to perform a punching operation on the sheet material to be punched carried on the mounting base.

Furthermore, the mounting base is provided with a handle installing shaft, and the control handle is defined with a handle installing hole which is mated with the handle installing shaft, wherein the mounting base and the control handle are rotatably connected by the handle installing shaft.

Furthermore, it further includes an elastic reset assembly, wherein the elastic reset assembly is sleeved on the handle installing shaft.

Furthermore, the elastic reset assembly is configured to automatically reset the control handle to an initial position after a punching process is completed.

Furthermore, the elastic reset assembly includes an elastic element and a contacting rod, wherein the contacting rod is fixedly connected to the mounting base.

Furthermore, the elastic element is sleeved on the handle installing shaft and abuts against the contacting rod.

Furthermore, it further includes a limiting assembly, wherein the limiting assembly is disposed between the mounting base and the control handle.

Furthermore, the limiting assembly is configured to lock the control handle at a lowest position of a swinging stroke.

Furthermore, the limiting assembly includes a limiting card and a control card, wherein the limiting card is sleeved on the handle installing shaft, and the limiting card is provided with a locking contact portion.

Furthermore, the control card is slidably connected to the mounting base, and the control card is provided with a control contact portion.

Furthermore, when the control handle is locked at the lowest position of the swinging stroke, the control contact portion selectively abuts against the locking contact portion.

Furthermore, when the control contact portion abuts against the locking contact portion, the limiting assembly overcomes an elasticity of the elastic reset assembly, to lock the control handle.

Furthermore, it further includes a driving gear and a transmission assembly, wherein the driving gear is fixedly sleeved on the handle installing shaft, and the driving gear is provided with a first gear component.

Furthermore, the mounting base is provided with an installation sliding rail, and the transmission assembly is vertically slidable along the installation sliding rail.

Furthermore, the transmission assembly is defined with a transmission engagement hole that engages with the first gear component.

Furthermore, when the control handle is rotated downward, the driving gear rotates, and through an engagement of the first gear component with the transmission engagement hole, the transmission assembly is driven to move downward along the installation sliding rail.

Furthermore, the transmission assembly further includes an executing card plate, wherein the executing card plate has an executing card slot.

Furthermore, the punching assembly includes a punching pressing plate and a punching blade, and the executing card slot is engaged with the punching pressing plate, with the punching pressing plate abutting against the punching blade: when the transmission assembly moves downward, the executing card plate is driven to move downward, thereby driving the punching blade downward through an engagement of the punching pressing plate to punch the sheet material to be punched carried on the mounting base.

Furthermore, it further includes a base positioning assembly, wherein the base positioning assembly is disposed on the mounting base for laterally adjusting a position of the sheet material to be punched.

Furthermore, the mounting base is provided with an installing recess, and an outer contour of a bottom of the replaceable punching core is matched with the installing recess.

The beneficial effects of the present disclosure are as follows: through the arrangement of the above structure, during use, the detachable installation design of the replaceable punching core allows the equipment to flexibly adapt to the punching needs of various sheet materials (such as paper, leather, plastic sheets, etc.) by replacing different specifications of the replaceable punching core. This not only reduces equipment acquisition costs but also simplifies the subsequent maintenance process. When the replaceable punching core is worn out or damaged, only the replaceable punching core needs to be replaced, and there is no need to disassemble the main equipment, effectively improving the versatility and lifespan of the equipment. The rotational connection structure between the control handle and the mounting base conforms to ergonomic principles. The rotating action drives the punching assembly downward, reducing the operational intensity. Additionally, users can precisely adjust the punching pressure and stroke by rotating the control handle, adapting to materials of different thicknesses and properties, preventing incomplete punching or material damage, and ensuring stable processing quality. The stable bearing of the sheet material by the mounting base reduces positional deviations during punching, while the simplified component layout allows the equipment to maintain a compact size, making it suitable for lightweight scenarios such as desktop operations and handcrafts. This balances processing precision and ease of use.

### BRIEF DESCRIPTION OF DRAWINGS

To better illustrate the technical solutions of the present disclosure's embodiments, a brief introduction to the drawings used in the embodiment description is provided below. The drawings mentioned are for some of the embodiments of the present disclosure. A person skilled in the art may, without inventive effort, derive other drawings based on these. Additionally, the drawings are not to scale, and the relative dimensions of the components in the drawings are shown for illustrative purposes and may not be drawn to actual proportions.

The present disclosure will be further explained in conjunction with the accompanying drawings and embodiments.

FIG. 1 is a schematic structural diagram of a punching machine with a replaceable punching core from a first view angle, with a control handle in an initial position, according to an embodiment of the present disclosure.

FIG. 2 is a schematic structural diagram of the punching machine with the replaceable punching core from a second view angle, with the control handle in the initial position, according to an embodiment of the present disclosure.

FIG. 3 is a schematic structural diagram of the punching machine with the replaceable punching core, with the control handle at a lowest position of a swinging stroke, according to an embodiment of the present disclosure.

FIG. 4 is an exploded view of the punching machine with the replaceable punching core.

FIG. 5 is an enlarged view of section A in FIG. 4.

FIG. 6 is an exploded view of a replaceable punching core of the punching machine with the replaceable punching core.

FIG. 7 is a schematic diagram for a scenario of punching holes in sheet materials of the punching machine with the replaceable punching core.

FIG. 8 is a schematic diagram for a scenario of ring binding of the punching machine with the replaceable punching core.

FIG. 9 is a schematic diagram for a scenario of ring binding of the punching machine with the replaceable punching core, shown in a different view angle of the FIG. 8.

### DESCRIPTION OF THE REFERENCE NUMERAL

100 mounting base, 200 replaceable punching core, 300 control handle, 400 elastic reset assembly, 500 limiting assembly, 600 driving gear, 700 transmission assembly, 800 base positioning assembly, 900 expand positioning assembly, 110 handle installing shaft, 120 installation sliding rail, 130 installing recess, 140 iron ring installing section, 150 iron ring crimping assembly, 151 crimping fixed plate, 152 crimping movable plate, 153 joining component, 1531 crimping engagement hole, 210 punching assembly, 211 punching pressing plate, 212 punching blade, 310 handle installing hole, 410 elastic element, 420 contacting rod, 510 limiting card, 511 locking contact portion, 520 control card, 521 control contact portion, 610 first gear component, 620 second gear component, 710 transmission engagement hole, 720 executing card plate, 721 executing card slot.

### DETAILED DESCRIPTION OF THE EMBODIMENTS

To make the objectives, features, and advantages of this disclosure more apparent and understandable, the following detailed description of the specific embodiments of this disclosure is provided in conjunction with the accompanying drawings. In the description below, many specific details are elaborated to facilitate a thorough understanding of this disclosure. However, this disclosure can be implemented in many ways different from those described here. A person skilled in the art can make similar improvements without departing from the essence of this disclosure. Therefore, the disclosure is not limited by the specific embodiments disclosed below.

In the description of this disclosure, it should be understood that when terms such as “center,” “longitudinal,” “transverse,” “length,” “width,” “thickness,” “up,” “down,” “front,” “back,” “left,” “right,” “vertical,” “horizontal,” “top,” “bottom,” “internal,” “external,” “clockwise,” “counterclockwise,” “axial,” “radial,” “circumferential,” etc., appear, the orientations or positional relationships indicated by these terms are based on the orientations or positional relationships shown in the accompanying drawings. These terms are used solely for the purpose of describing this disclosure and simplifying the description, and are not intended to indicate or imply that the punching machine or component referred to must have a specific orientation or be constructed and operated in a specific orientation. Therefore, they should not be interpreted as limitations of this disclosure.

Additionally, when terms such as “first” and “second” appear, these terms are used only for descriptive purposes and should not be interpreted as indicating or implying relative importance or suggesting the quantity of the technical features they refer to. Thus, features labeled as “first” and “second” may explicitly or implicitly include at least one such feature. In the description of this disclosure, if the term “multiple” is used, it refers to at least two, such as two, three, etc., unless otherwise specifically limited.

In this disclosure, unless explicitly specified otherwise, when terms like “install.” “connected,” “fixed,” etc., are used, they should be broadly interpreted. For example, the connection could be fixed or detachable, or could be integrated into a single piece. It could be a mechanical connection or an electrical connection. It could be a direct connection or an indirect connection via an intermediary. It could refer to internal communication between two components or an interaction between two components, unless otherwise specifically limited. Those skilled in the art can interpret these terms based on the specific context in this disclosure.

In this disclosure, unless explicitly specified otherwise, when a first feature is described as being “on,” “above,” “below,” or similar with respect to a second feature, it means that the first and second features may be in direct contact, or may be indirectly connected through an intermediary. Moreover, “on,” “above,” and “top” could mean that the first feature is directly or obliquely above the second feature, or simply that the first feature is at a higher level than the second. Similarly, “below,” “under,” and “bottom” could mean that the first feature is directly or obliquely below the second feature, or simply that the first feature is at a lower level than the second.

It should be noted that when a component is described as “fixed to” or “arranged on” another component, it may be directly placed on the other component, or it could be an intermediary component in between. If a component is described as “connected” to another component, it could be directly connected, or it may have an intermediary component. The terms “vertical,” “horizontal,” “up,” “down,” “left,” “right.” and similar expressions used in this disclosure are for descriptive purposes only and do not indicate a unique implementation method.

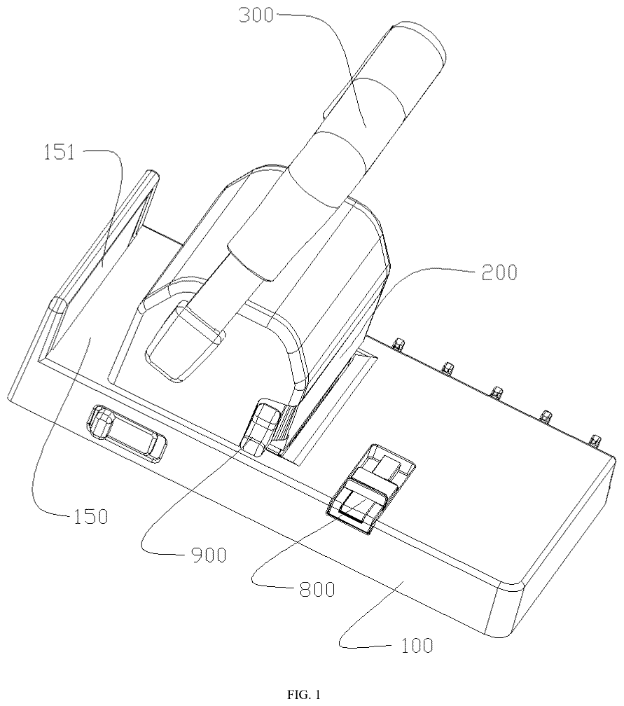

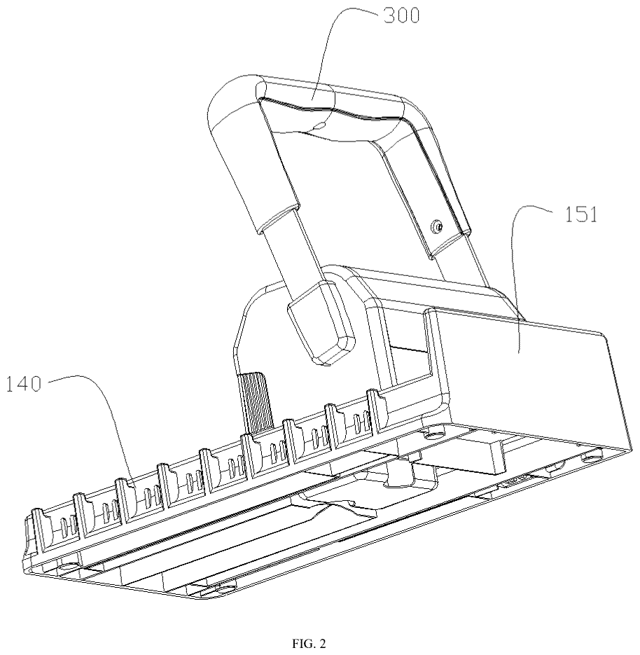

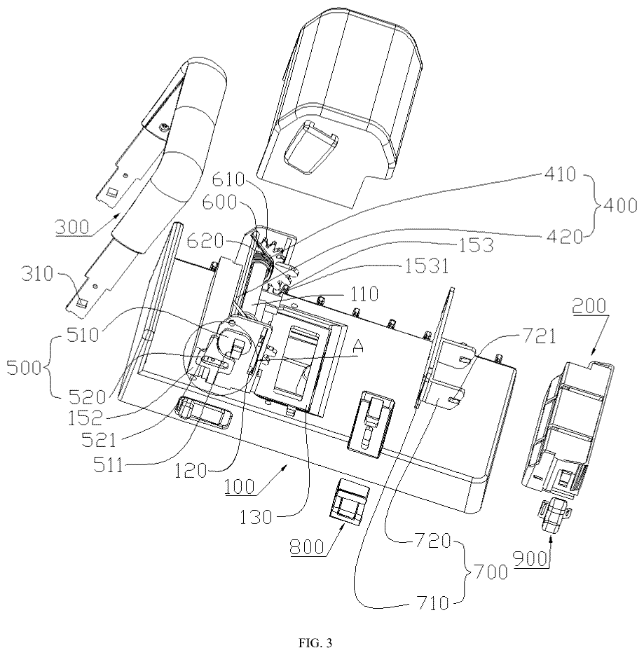

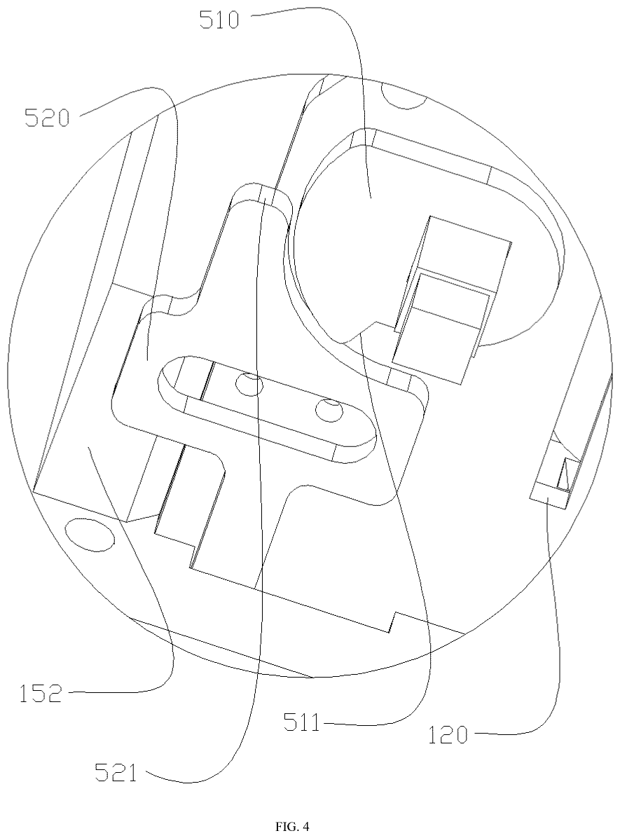

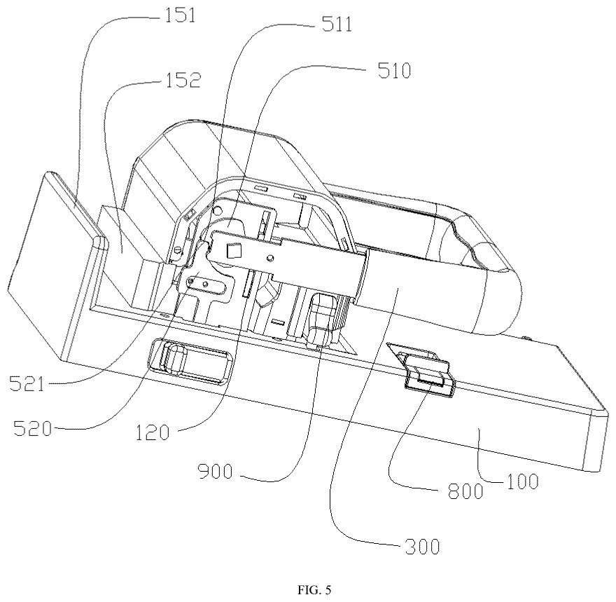

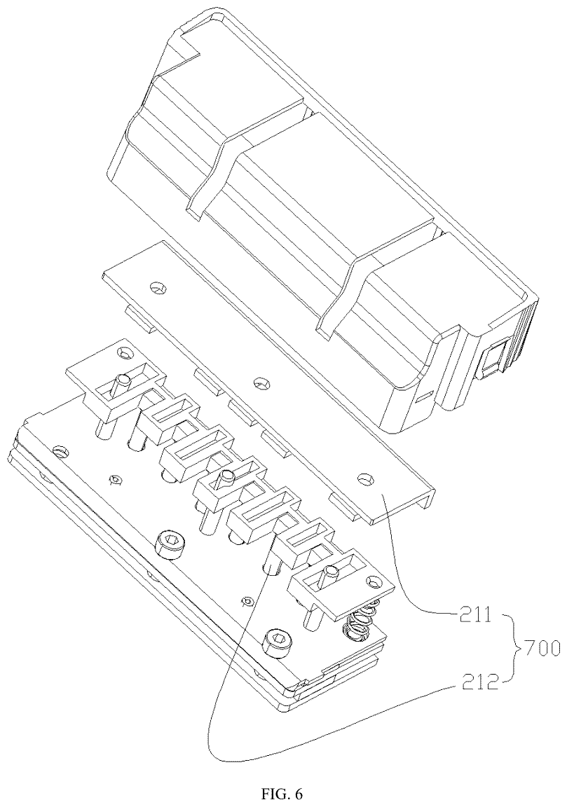

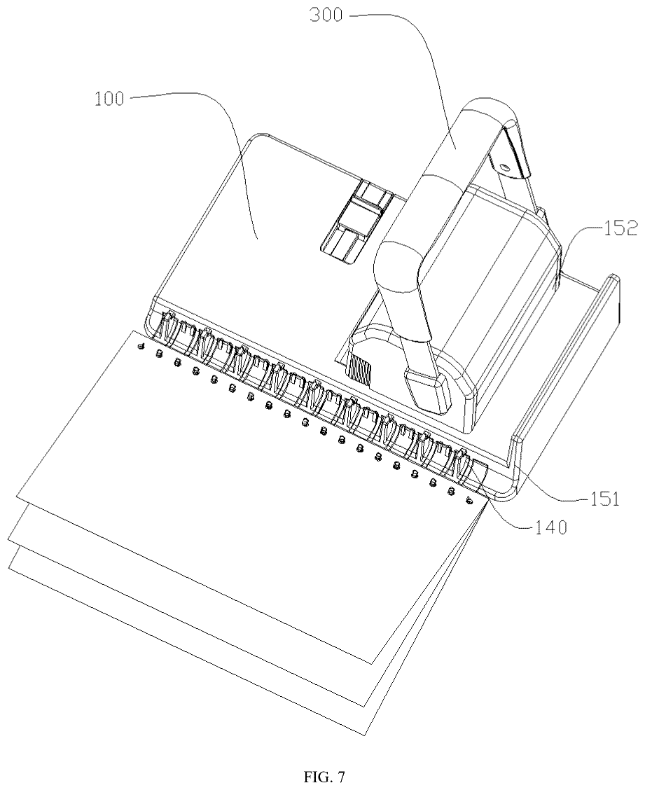

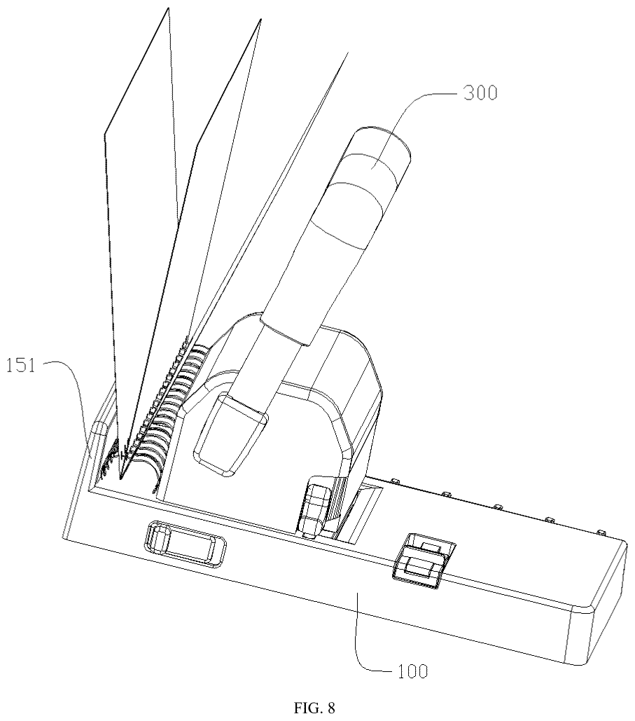

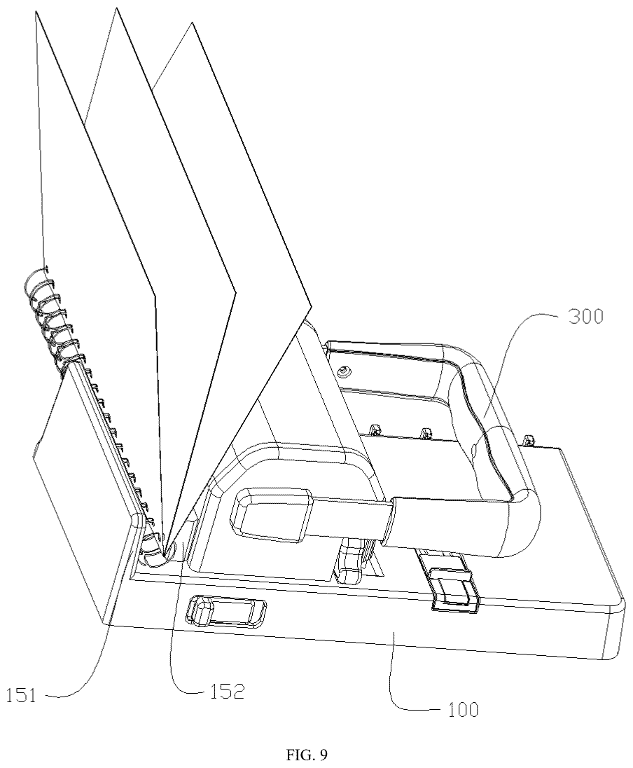

With reference to FIGS. 1 to 9, in this embodiment, a punching machine with a replaceable punching core includes: a mounting base 100, which is used for carrying a sheet material to be punched. A replaceable punching core 200, which is detachably mounted on the mounting base 100, and replaceable punching core 200 includes a punching assembly 210. A control handle 300, which is rotatably connected to the mounting base 100, and a rotation of the control handle 300 drives the punching assembly 210 of the replaceable punching core 200 to move downward to perform punching on the sheet material carried on the mounting base 100.

Through the above structures, during use, the mounting base 100 serves as a foundational supporting structure, providing a stable platform for the sheet material to be punched, ensuring the material's position is fixed during a punching process and serving as a reference for an entire device operation. The replaceable punching core 200 is connected to the mounting base 100 in a detachable manner. The punching assembly 210 contained within the replaceable punching core 200 is a core component that performs the punching operation. The detachable design allows the punching machine to quickly swap in different replaceable punching cores 200 to meet varying punching needs, greatly improving the punching machine's versatility and flexibility. The control handle 300 is rotatably connected to the mounting base 100. By rotating the control handle 300, the operator drives the punching assembly 210 to move downward, performing the punching operation with mechanical drive, simplifying the operation process while ensuring the stability and controllability of the punching force through the force transmission of the control handle 300. Overall, the punching machine achieves convenient, precise, and flexible punching operations through the functional division and interaction of its components.

In this embodiment, the mounting base 100 is equipped with a handle installing shaft 110, and the control handle 300 is provided with a handle installing hole 310 that cooperates with the handle installing shaft 110. The mounting base 100 and the control handle 300 are rotatably connected via the handle installing shaft 110. In use, the handle installing shaft 110 provided by the mounting base 100 and the handle installing hole 310 of the control handle 300 form an accurate fit. From the connection perspective, the two components achieve a rotatable connection between the mounting base 100 and the control handle 300 via the shaft hole, providing a stable rotation pivot for the control handle 300 to ensure that no loosening or misalignment occurs during rotation, thereby ensuring the stability of the punching machine. From the transmission perspective, this connection structure allows the operator to precisely and efficiently transfer the force when rotating the control handle 300 to the punching assembly 210 of the replaceable punching core 200, driving it to move downward steadily to complete the punching action, thus avoiding issues such as poor punching results caused by force loss or transmission deviation. Additionally, this simple and easy-to-manufacture design lowers production and manufacturing costs, facilitates subsequent maintenance and repairs, and further enhances the punching machine's practicality and reliability, aligning with the overall design goal of efficient and flexible punching.

In this embodiment, the punching machine also includes an elastic reset assembly 400, which is mounted around the handle installing shaft 110, and is used to automatically reset the control handle 300 to its initial position after punching is completed. During use, the elastic reset assembly 400 mounted around the handle installing shaft 110 serves as an important optimization of the overall structure of the punching machine with the replaceable punching core, forming an efficient collaboration with the existing components. From an operational cycle perspective, once punching is completed, the elastic reset assembly 400 uses its own elastic force to drive the control handle 300 to automatically return to its initial position, eliminating the need for manual resetting. This significantly simplifies the operation process, reduces steps during continuous punching operations, and improves work efficiency. From the structural integration perspective, the way it is mounted around the handle installing shaft 110 makes full use of the existing shaft structure, without the need for additional mounting components. This not only saves space but also ensures the stability of the reset force transmission, thanks to the precise fit between the handle installing shaft 110 and the handle installing hole 310, the reset force is evenly applied to the control handle 300, preventing sticking or misalignment during the reset process, and ensuring that the control handle 300 returns accurately to the initial position, providing a stable starting point for the next punching operation. At the same time, this design further improves the automation function of the punching machine, complementing the flexibility of the replaceable punching core 200 and a precision of the control handle 300's drive, making the entire punching operation more fluid in the “drive-punch-automatic reset” cycle, enhancing the punching machine's practicality and ease of operation.

In this embodiment, the elastic reset assembly 400 includes an elastic element 410 and a contacting rod 420. The contacting rod 420 is fixedly connected to the mounting base 100, and the elastic element 410 is mounted around the handle installing shaft 110 and presses against the contacting rod 420. During use, a coordination between the elastic element 410 and the contacting rod 420 in the elastic reset assembly 400 further refines and strengthens its functionality. The contacting rod 420 is fixed to the mounting base 100, providing a stable support point for the clastic element 410. When the elastic element 410 is mounted around the handle installing shaft 110 and presses against the contacting rod 420, this fixed support ensures that after the elastic element is deformed (e.g., when the control handle rotates to compress the elastic element during punching), it can release its elastic potential energy precisely to drive the control handle 300 to reset, preventing insufficient reset force or directional deviation caused by unstable support. Furthermore, the way the clastic element 410 is mounted around the handle installing shaft 110, in coordination with the fixed support of the contacting rod 420, creates a clear path for transmitting the elastic force—along the handle installing shaft 110 to the control handle 300. Combined with the precise fit between the handle installing shaft 110 and the handle installing hole 310, reducing energy loss and positional deviation during the reset process, ensuring accuracy and consistency in the reset.

This embodiment also includes a limiting assembly 500, which is positioned between the mounting base 100 and the control handle 300, and is used to selectively lock the control handle 300 at a lowest position of a swinging stroke. During use, the limiting assembly 500, positioned between the mounting base 100 and the control handle 300, allows the control handle 300 to be locked at the lowest position of the swinging stroke. This design serves as an important supplement to the punching machine's functionality, forming deep collaboration with the existing structure. From a functional coordination perspective, the selectable locking feature does not interfere with the automatic reset cycle of the control handle 300 under the action of the elastic reset assembly 400 during normal punching. However, it can achieve precise locking in special cases, balancing the punching machine's efficiency in regular operation with safety in specific scenarios. Additionally, the limiting component is installed between the mounting base 100 and the control handle 300, making full use of the connection space between the two components, while forming a compact integration with the handle installing shaft 110, elastic reset assembly 400, and other structures. This not only saves space but also ensures the stability of the reset force transmission, improving the rationality and practicality of the punching machine structure. It is also helpful when packaging and transporting the product, as locking the control handle 300 in the lowest position of the swinging stroke reduces packaging space requirements of the punching machine.

In this embodiment, the limiting assembly 500 includes a limiting card 510 and a control card 520. The limiting card 510 is mounted around the handle installing shaft 110 and includes a locking contact part 511. The control card 520 is slidably connected to the mounting base 100 and includes a control contact part 521. When the control handle 300 is locked at the lowest position of the swinging stroke, the control contact part 521 selectively presses against the locking contact part 511 to overcome the force of the elastic reset assembly 400, locking the control handle 300. During use, the coordination between the limiting card 510 and the control card 520 in the limiting assembly 500 makes the locking function more precise and reliable. The limiting card 510 is mounted around the handle installing shaft 110 and has the locking contact part 511, which works with the control contact part 521 of the control card 520. When the control handle 300 needs to be locked, the control card 520 is slid (this embodiment uses a sliding control key connected to the mounting base 100, which locks into the control card 520 to control its sliding), causing the two contact parts to press against each other. This can stabilize and overcome the force of the elastic reset assembly 400, ensuring that the control handle 300 remains at the lowest position without rebounding. This structure, with clear contact relations to transmit force, enhances the stability of the locking mechanism, and the sliding control operation is simple and easy, ensuring that the locking function is effectively implemented without interfering with the punching machine's normal operation. This improves the operational reliability of the punching machine.

The punching machine also includes a driving gear 600 and a transmission assembly 700. The driving gear 600 is fixedly mounted around the handle installing shaft 110 and has a first gear component 610. The mounting base 100 has an installation sliding rail 120, and the transmission assembly 700 is vertically slidable on the installation sliding rail 120 and has a transmission engagement hole 710 that meshes with the first gear component 610. When the control handle 300 is rotated downward, the driving gear 600 rotates and drives the transmission assembly 700 along the installation sliding rail 120 to move downward via the engagement of the first gear component 610 with the transmission engagement hole 710. During use, the design of the driving gear 600 and the transmission assembly 700 optimizes the force transmission and motion conversion. The driving gear 600 is fixedly mounted around the handle installing shaft 110 and rotates with the control handle 300. The first gear component 610 meshes with the transmission engagement hole 710 of the transmission assembly 700, converting the rotational movement of the handle into vertical downward movement of the transmission assembly along the installation sliding rail 120. This meshing drive is precise and stable, efficiently transmitting power to ensure even force on the punching assembly 210. The installation sliding rail 120 provides guidance for the transmission assembly, ensuring stable movement. The driving gear 600 and the transmission assembly 700, when integrated with the handle installing shaft 110 and the elastic reset assembly 400, enhances the accuracy and reliability of the punching action, further improving the punching machine's transmission system.

In this embodiment, the transmission assembly 700 further includes an executing card plate 720, which is equipped with an executing card slot 721. The punching assembly 210 includes a punching pressing plate 211 and a punching blade 212. The executing card slot 721 engages with the punching pressing plate 211, which presses against the punching blade 212. When the transmission assembly 700 moves downward, it drives the executing card plate 720 downward, which then drives the punching pressing plate 211 to push the punching blade 212 downward, thus punching the sheet material carried on the mounting base 100. During use, the executing card plate 720 of the transmission assembly 700 engages with the punching pressing plate 211 of the punching assembly 210 through the executing card slot 721. The punching pressing plate 211 then presses against the punching blade 212, allowing the precise transmission of force from the transmission assembly 700 to the punching blade 212. As the transmission assembly 700 moves downward along the installation sliding rail 120, the executing card plate 720 drives the punching pressing plate 211 to move in synchrony, pushing the punching blade 212 to apply force and punch the sheet material. This engagement ensures direct and non-deviating force transmission, preventing power loss. Additionally, the punching pressing plate 211 ensures that the punching blade 212 experiences a more uniform force, reducing potential damage or deformation of the blade caused by excessive localized force and improving punching quality. This structure, combined with the driving gear 600 and the transmission assembly 700, forms a complete power transmission chain, further enhancing the stability and accuracy of the punching machine's punching action, aligning with the goal of efficient and reliable punching in the overall design.

In this embodiment, the punching machine also includes a base positioning component 800, which is mounted on the mounting base 100 to laterally adjust the position of the sheet material to be punched. During use, the base positioning component 800, mounted on the mounting base 100, allows for lateral adjustment of the sheet material's position. This is a crucial feature for ensuring the accuracy of punching. The component can adjust the lateral position of the sheet material based on punching requirements, ensuring the punching position is accurate. It complements the flexible adaptation of the replaceable punching core 200, expanding the punching machine's ability to accommodate different punching requirements. Additionally, this component works in conjunction with the transmission assembly 700 and the punching assembly 210. Once the position of the sheet material to be punched is determined, precise power transmission and punching actions ensure consistent and reliable punching, making the punching machine better suited for diverse punching position requirements while maintaining high operational efficiency and functionality.

In this embodiment, the punching machine with the replaceable punching core further includes an expansion positioning component 900, which is mounted on the replaceable punching core 200 to laterally adjust the position of the sheet material that already has some punched holes. During use, the expansion positioning component 900, mounted on the side of the replaceable punching core 200, is specifically designed for scenarios where the sheet material to be punched exceeds a base size and requires multiple punches along the edges. It complements the base positioning component 800. The expansion positioning component 900 allows for lateral adjustment of the sheet material that already has some punched holes, ensuring that edge holes are evenly distributed during multiple punching operations. When the sheet material exceeds the base's size, the expansion positioning component 900 can precisely control its movement, maintaining punching accuracy and meeting the need for uniform edge punching, further expanding the punching machine's ability to handle large sheet material to be punched and perfecting the positioning adjustment system.

In this embodiment, the punching machine with the replaceable punching core also includes an installation recessed groove 130 on the mounting base 100, where the outer contour at the bottom of the replaceable punching core 200 matches the installation recessed groove 130.

With this structure, during use, the matching design between the installation recessed groove 130 of the mounting base 100 and the outer contour at the bottom of the replaceable punching core 200 provides precise installation positioning for the replaceable punching core 200. This matching structure ensures that the replaceable punching core 200 is stably fitted into the mounting base 100, preventing lateral shifts or wobbling during punching, and ensuring the accuracy of the punching position. Additionally, it works in conjunction with the expansion positioning component 900 and other components, providing a reliable foundation for sheet material positioning and punching accuracy during multiple punching operations. It also facilitates the quick disassembly and replacement of the replaceable punching core 200, further enhancing the punching machine's stability and ease of operation. It is worth noting that the bottom of the installation recessed groove 130 also has a waste discharge port, and the bottom of the mounting base 100 has a waste collection box directly beneath the waste discharge port. The waste generated during punching will fall through the discharge port into the waste collection box.

In this embodiment, the punching machine with the replaceable punching core also includes an iron ring installing section 140 and an iron ring crimping assembly 150 on the mounting base 100. The iron ring installing section 140 assists in installing the binding iron ring for the sheet material after punching. The iron ring crimping assembly 150 includes a crimping fixed plate 151, a crimping movable plate 152, and a joining component 153. The joining component 153 is fixedly connected to the crimping movable plate 152 and has a crimping engagement hole 1531. The driving gear 600 also has a second gear component 620. When the control handle 300 rotates downward, the driving gear 600 rotates and, through the engagement of the second gear component 620 with the crimping engagement hole 1531, drives the joining component 153, further moving the crimping movable plate 152 toward the crimping fixed plate 151 and crimping the binding iron ring between them. During use, the iron ring installing section 140 and the iron ring crimping assembly 150 extend the functionality of the punching machine, enabling an integrated operation of punching and binding sheet materials. The iron ring installing section 140 assists in installing the binding iron ring for the punched sheet material, improving the convenience of binding preparation. In the iron ring crimping assembly 150, the joining component 153 engages with the second gear component 620 of the driving gear 600 through the crimping engagement hole 1531. When the control handle 300 is rotated, the driving gear 600 drives the crimping movable plate 152 toward the crimping fixed plate 151, completing the crimping of the iron ring. This design reuses the power transmission from the driving gear 600, eliminating the need for an additional power source and simplifying the structure. This assembly works in coordination with the punching-related structures, making the punching machine's operations more cohesive and efficient from punching to binding, enhancing overall practicality.

As described above, one or more embodiments are provided in connection with specific content and are not meant to limit the disclosure to these descriptions. Any methods, structures, or substitutions that are similar or based on the ideas of the disclosure should be considered within the scope of the disclosure's protection.

What is claimed is:

1. A punching machine with a replaceable punching core, comprising:
a mounting base, which is configured for carrying a sheet material to be punched; and
a replaceable punching core, which is detachably mounted on the mounting base, and the replaceable punching core comprises a punching assembly; and
a control handle, which is rotatably connected to the mounting base: when the control handle rotates, the punching assembly of the replaceable punching core is driven to move downward, to perform a punching operation on the sheet material to be punched carried on the mounting base.

2. The punching machine with the replaceable punching core of claim 1, wherein the mounting base is provided with a handle installing shaft, and the control handle is defined with a handle installing hole which is mated with the handle installing shaft, wherein the mounting base and the control handle are rotatably connected by the handle installing shaft.

3. The punching machine with the replaceable punching core of claim 2, wherein it further comprises an elastic reset assembly, wherein the elastic reset assembly is sleeved on the handle installing shaft.

4. The punching machine with the replaceable punching core of claim 3, wherein the elastic reset assembly is configured to automatically reset the control handle to an initial position after a punching process is completed.

5. The punching machine with the replaceable punching core of claim 4, wherein the elastic reset assembly comprises an elastic element and a contacting rod, wherein the contacting rod is fixedly connected to the mounting base.

6. The punching machine with the replaceable punching core of claim 5, wherein the elastic element is sleeved on the handle installing shaft and abuts against the contacting rod.

7. The punching machine with the replaceable punching core of claim 3, wherein it further comprises a limiting assembly, wherein the limiting assembly is disposed between the mounting base and the control handle.

8. The punching machine with the replaceable punching core of claim 7, wherein the limiting assembly is configured to lock the control handle at a lowest position of a swinging stroke.

9. The punching machine with the replaceable punching core of claim 8, wherein the limiting assembly comprises a limiting card and a control card, wherein the limiting card is sleeved on the handle installing shaft, and the limiting card is provided with a locking contact portion.

10. The punching machine with the replaceable punching core of claim 9, wherein the control card is slidably connected to the mounting base, and the control card is provided with a control contact portion.

11. The punching machine with the replaceable punching core of claim 10, wherein, when the control handle is locked at the lowest position of the swinging stroke, the control contact portion selectively abuts against the locking contact portion.

12. The punching machine with the replaceable punching core of claim 11, wherein, when the control contact portion abuts against the locking contact portion, the limiting assembly overcomes an elasticity of the elastic reset assembly, to lock the control handle.

13. The punching machine with the replaceable punching core of claim 3, wherein it further comprises a driving gear and a transmission assembly, wherein the driving gear is fixedly sleeved on the handle installing shaft, and the driving gear is provided with a first gear component.

14. The punching machine with the replaceable punching core of claim 13, wherein the mounting base is provided with an installation sliding rail, and the transmission assembly is vertically slidable along the installation sliding rail.

15. The punching machine with the replaceable punching core of claim 14, wherein the transmission assembly is defined with a transmission engagement hole that engages with the first gear component.

16. The punching machine with the replaceable punching core of claim 15, wherein, when the control handle is rotated downward, the driving gear rotates, and through an engagement of the first gear component with the transmission engagement hole, the transmission assembly is driven to move downward along the installation sliding rail.

17. The punching machine with the replaceable punching core of claim 16, wherein the transmission assembly further comprises an executing card plate, wherein the executing card plate has an executing card slot.

18. The punching machine with the replaceable punching core of claim 17, wherein the punching assembly comprises a punching pressing plate and a punching blade, and the executing card slot is engaged with the punching pressing plate, with the punching pressing plate abutting against the punching blade; when the transmission assembly moves downward, the executing card plate is driven to move downward, thereby driving the punching blade downward through an engagement of the punching pressing plate to punch the sheet material to be punched carried on the mounting base.

19. The punching machine with the replaceable punching core of claim 1, wherein it further comprises a base positioning assembly, wherein the base positioning assembly is disposed on the mounting base for laterally adjusting a position of the sheet material to be punched.

20. The punching machine with the replaceable punching core of claim 1, wherein the mounting base is provided with an installing recess, and an outer contour of a bottom of the replaceable punching core is matched with the installing recess.
